(19) United States
(12) Patent Application Publication
(10) Pub. No.: US 2014/0025432 A1
(43) Pub. Date: Jan. 23, 2014

(54) METHODS AND SYSTEMS FOR OBTAINING INFORMATION

(71) Applicants: Erik Thomassen, Amsterdam (NL); Floor Hendrik Van Der Wateren, Amsterdam (NL)

(72) Inventors: Erik Thomassen, Amsterdam (NL); Floor Hendrik Van Der Wateren, Amsterdam (NL)

(21) Appl. No.: 13/977,886

(22) PCT Filed: Dec. 30, 2010
(86) PCT No.: PCT/EP2010/070943

§ 371 Date: Sep. 12, 2013

(51) Int. Cl. G06Q 30/02

(52) U.S. Cl. CPC G06Q 30/0205
USPC 705/7.34

(57) ABSTRACT

A predetermined geographic region is associated with a building offering goods or services. The region has a shape and size chosen depending upon the type and/or location of the building to define a region of relevance of the building. Probe data is used to identify probe devices which enter the region, and to include the devices in a database. The database is provided to someone wishing to promote the services or goods provided by the building to enable promotional material to be sent to users associated with the devices. As the devices were found in the predetermined region, the users are considered to be potential local users of the building.

### FIELD OF THE INVENTION

This invention relates to methods and systems for obtaining information regarding potential users of buildings offering goods and/or services, or of visitor attractions. The invention also extends to a central controller for carrying out methods in accordance with the invention, and methods of operating a central controller. Illustrative embodiments of the invention relate to portable navigation devices (so-called PNDs), in particular PNDs that include Global Positioning System (GPS) signal reception and processing functionality.

### BACKGROUND TO THE INVENTION

The present invention is directed, at least in some aspects and embodiments, to methods and systems which may utilise probe devices in the form of navigation apparatus. The apparatus may be of any suitable form as discussed above, and in more detail below. One illustrative embodiment of the apparatus is a portable navigation device comprising the apparatus of the invention. Portable navigation devices (PNDs) that include GPS (Global Positioning System) signal reception and processing functionality are well known and are widely employed as in-car or other vehicle navigation systems.

In general terms, a modern PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In a particularly preferred arrangement the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Wi-Fi, Wi-Max GSM and the like.

PND devices of this type also include a GPS antenna by means of which satellite-broadcast signals, including location data, can be received and subsequently processed to determine a current location of the device.

The PND device may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server to which the user's PC is connected calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the GO 950 LIVE model manufactured and supplied by TomTom International B.V., provide a reliable means for enabling users to navigate from one position to another.

In recent times, it has become usual in relation to Internet based advertising to try to direct content or advertising towards certain individuals to whom the advertising may be relevant. This may be on the basis of the type of search an individual has performed which may be used to determine products or services which may be of interest to the individual. Such targeted content may allow service or product providers to more efficiently direct campaigns, rather than relying upon general indiscriminate campaigns. However, the Applicant has realised that in non Internet based contexts, i.e. in the real world, business owners and others wishing to promote services or products still tend to rely upon conventional techniques in which advertising or content is not targeted. In particular, the Applicant has realised that there remains a need for improved techniques to identify potential users of buildings offering goods and/or services, or of visitor attractions, on the basis of geographic relevance of the building or attraction to the user.

The present invention provides methods and systems which may be used to obtain information identifying potential local users of a building offering goods and/or services.

### SUMMARY OF THE INVENTION

In accordance with a first aspect of the invention there is provided a method comprising the steps of;

associating at least one predetermined geographic region with one of a building offering goods and/or services or a visitor attraction;
wherein the method comprises selecting a shape and size of the predetermined region based on a type and/or location of the building or attraction;
using probe data to obtain information identifying one or more probe devices which are or have been present in the or each predetermined region,
and using the obtained information to generate a database of potential users of the building or attraction.

In accordance with a second aspect of the invention there is provided a system comprising;

means for associating at least one predetermined geographic region with one of a building offering products and/or services or a visitor attraction;
wherein a shape and size of the predetermined region is selected based on a type and/or location of the building or attraction;
means for using probe data to obtain information identifying one or more probe devices which are or have been present in the or each predetermined region,
and means for using the obtained information to generate a database of potential users of the building or attraction.

The present invention in accordance with the second aspect of the invention may include any or all of the features described in relation to the first aspect of the invention. The methods of the invention may therefore comprise any of the steps of the method described as being performed by the system of the invention, and the system of the invention may comprise means for carrying out any of the steps of the methods of the invention.

It will be appreciated that references to a system or apparatus comprising “means for” carrying out any given step herein may refer to there being a set of one or more processors for carrying out the step. References to “means for” may therefore be replaced by a reference to “a set of one or more processors”. Each step may be performed by the same set of processors, a different set of processors, or a set of processors including one or more common processors.

The Applicant has realised that for physical entities wishing to attract users, i.e. buildings offering goods and/or services, or visitor attractions, such as shops, leisure centres, stadiums, historical houses etc, it is desirable to be able to identify potential users who may be considered “local” in some sense. A local user could be someone who lives nearby, or at least sometimes passes by the building or attraction, or within a given proximity of the building or attraction. By building a database of such potential local users, content or advertising for the building or attraction may be more effectively be directed towards those who may be likely to use the building or attraction based at least upon geographical factors. In other words, it is desirable to be able to identify potential users to whom the building or attraction is relevant at least geographically.

It will be appreciated that references to the “building or attraction” herein refer to the building offering goods and/or services, or the visitor attraction.

Accordingly, in embodiments of the invention, at least one predetermined geographic region (“the predetermined region”) is associated with the building or attraction, and probe data is used to identify probe devices which are/have been present in the or each given predetermined region associated with the building or attraction.

It will be appreciated that references to the, each or a “region” herein refer to the, each or a “predetermined region” unless the context demands otherwise. The probe data is used to identify potential local users of the building or attraction i.e. those who the probe data suggests have entered the region associated with the building or attraction. In this way, a database of potential users for whom the products or services offered by the building, or for whom the visitor attraction may be considered at least geographically relevant may be automatically compiled.

References to a “local” potential user herein, refer to a person associated with a probe device which is or has been present in the predetermined region associated with a building or attraction. Thus the user is a user for whom the building or attraction may be considered of geographic relevance on the basis of their being associated with a probe device that has been found in a predetermined region associated with the building or attraction. The user may not be local in the sense of living in the region, or close to the region, but may be assumed at least have visited the region associated with the building or attraction. The building or attraction is taken to be of geographic relevance to the user as they are assumed to have visited the region associated with the building or attraction at least once by virtue of the probe device having visited the region. As discussed below, the shape and size of the region is selected with reference to a type or location of the building or attraction, and may therefore define a region of geographical relevance of the building or attraction, such that the building or attraction may be assumed to be of potential relevance to a person found within the region. Unless explicitly stated, references to the relevance of the building or promoting the building herein refer to the relevance of the goods or services offered by the building, or promoting of the goods or services.

It will be appreciated that the present invention relies upon probe data to identify probe devices present, or which have been present in the region. The method may comprise the step of collecting probe data from each of a plurality of probe devices, and the system comprises means for so doing. In preferred embodiments in which the system comprises a central controller, the central controller comprises such means. The system may comprise the plurality of probe devices.

As used herein references to “probe data” or “probe device” take on their customary meaning in the art. A probe device is a device that is capable of determining its position at different times, and providing information about its position at different times to a central controller. In this way the central controller is provided with position data for the probe device at different times which may be used to obtain a “trace” of the path taken by the device. The position data is typically GPS position data for the device. For example, in some systems, the position of the probe device may be uploaded every 5 seconds. In embodiments the central controller therefore collects individual position traces for each of a plurality of probe devices.

A probe device may provide the position and time information to the central controller in any manner. The device may automatically and periodically determine position and time information and upload the position and time information to the central controller. For example, position information may be uploaded with a time stamp for different times. In these arrangements, the device may upload the information in real-time, i.e. periodically provide position information to the central controller for a current time, or may store the information and upload it to the central controller at intervals, or upon request of the central controller etc. In other arrangements the probe device could store position information for different times and upload the position information with a time stamp for different times to a central controller only upon intervention by a user e.g. to prompt the device to upload the information.

In preferred embodiments in which the system comprises a central controller, the central controller receives position information for different times for each of a plurality of probe devices to enable the central controller to determine a probe trace representing a path taken by each device, and the system comprises means for so doing.

In accordance with the invention, the method comprises using the probe data to obtain information identifying one or more probe devices that are or have been present in the or each said predetermined region associated with the building or attraction. Such a step may be carried out by a central controller, where provided. In embodiments the region is a region of a digital map representative of a geographic region, and the method comprises determining when a GPS position of a probe device is or has been present in the predetermined region of the digital map. The system preferably comprises means for carrying out such a step. It will be appreciated that the step of determining that a probe device has been present in the predetermined region may be carried out while the device is in the region, or at a later stage e.g. using stored probe data. Thus the process may or may not be carried out in real time.

The step of identifying when a probe device is or has been present in a predetermined region may comprise determining when at least a portion of a probe trace of the probe device is found within the predetermined region, and the system may comprise means for carrying out such a step. This may be carried out, for example, by comparing probe traces for probe devices with a region of a digital map representing the predetermined region, such as by overlaying the probe traces on the digital map. The probe device may be present in the region for an extended period, e.g. when the owner lives in the region, or may only briefly be found in the region e.g. if the owner drives through the region on the way to work.

The identified probe devices are used to at least indirectly identify potential users of a building or attraction. The potential users are users associated with the identified probe devices. The users are potential local users as discussed above, as they are assumed to have been present in a predetermined region. Thus as referred to herein, the database of potential users may be a database of the probe devices found to be or have been present in the predetermined region. The database may therefore comprise the information obtained identifying the one or more probe devices found to be or have been present in the predetermined region. In some embodiments, information identifying a user associated with the or each probe device may be stored in the database. However, this is not necessary. Information identifying a probe device may be used to contact a user of the probe device, and it is assumed that the user of the probe device was present with the probe device when the probe device was present in the predetermined region. In other words, it is assumed that the user of the probe device is a potential local user. Thus, in some embodiments, the database is a database of the probe devices found to have been present or being present in the predetermined region. The data stored may then be effectively anonymous, but information identifying individual devices provides a way of contacting an individual associated with the device.

The probe devices from which the probe data used herein is obtained may be any type or types of probe device. In embodiments of the invention, the probe data is data derived from probe devices in the form of mobile communications devices and/or navigation devices. The probe device should ideally be representative of the movements of a person associated with the device, such that the presence of the device in the predetermined region can be considered indicative of the presence of a person associated with the device in the region. This enables the information identifying the device to provide information regarding a potential local user in the database. The device is preferably a device of a type associated with an individual user, or at least with an individual user profile. In preferred embodiments the data is derived from portable probe devices such as probe devices in the form of mobile phones and/or portable navigation devices.

In accordance with the invention, the information obtained identifying the one or more probe devices is used to generate a database. It will be appreciated that the generation of the database may involve creating a new database, adding information to an existing database, modifying information in an existing database etc. The database may comprise information derived from multiple sources, including using the techniques of the present invention, or obtained solely using techniques of the present invention.

The step of using the obtained information identifying the one or more probe devices which are or have been present in the or a predetermined region to generate a database of potential users of the building or attraction may be carried out by a central controller where provided. The step may comprise storing the information identifying the one or more probe devices in a database. Accordingly, in embodiments the database comprises information identifying the one or more probe devices which are or have been present in the or a predetermined region. Preferably the information identifying the one or more probe devices comprises an identifier for the or each probe device. The information preferably comprises information enabling a user of the device to be contacted e.g. by email, text message, voice message, by telephone etc. The method may comprise storing information which enables a communications link to be established with the or each probe device for contacting a user of the device e.g. to enable information to be sent to the device. For example, the information may be a subscriber number or identity which may allow contact to be established with the device e.g. to enable voice and/or text communication. The information may comprise a telephone number for a device in the form of a mobile telephone.

It will be appreciated that the information identifying the one or more probe devices that are or have been present in the predetermined region indirectly provides information identifying potential users of the building or attraction. Each probe device may be considered to be associated with a person who is a potential user of the building or attraction. Thus obtaining and storing information identifying the or each probe device in the database effectively provides information which may be used to contact potential users of the building or attraction.

In some embodiments the step of using the obtained information to generate the database may comprise using the obtained information to identify a person associated with the or each probe device found to be or have been present in the region, and the system may comprise means for carrying out such a step. The identified person associated with the device may be a person to whom the device is registered. The identity of the person may be included in the database. Information identifying a person associated with the or each probe device may be stored in addition to or alternatively to information identifying the device.

In some embodiments, the step of determining an identity of a person associated with the device may further comprise determining the identity of a person having a user profile on the device that is active when the device is within the predetermined region. This step may be appropriate in cases where a device is shared by multiple persons. The database may then be provided to, for example, a person associated with the building or attraction. The person may be provided with a list of contact information for potential users i.e. customers to whom, for example, promotions could be directed. As the potential users are assumed to have been in the vicinity of the building or attraction, the person can have the confidence that the promotion will be of some relevance to the targeted user, at least geographically.

It will be appreciated that the methods of the present invention involve tracking the movements of probe devices. It may be necessary for a user associated with a device to give their consent for probe data derived from the device to be used at least for the purposes of the present invention. Thus the probe devices from which the information identifying the potential users of the is derived in accordance with the invention may be derived from a subset of probe devices found in the predetermined region for which the probe data is authorised to be used for the purposes of the invention. The devices may be devices of subscribers to certain navigation or telecommunications systems who have consented to the use of probe data derived from their devices in this manner. The method may comprise determining whether consent has been given for information identifying the device to be included in the database, and including information identifying the device in the database when consent has been given. In some embodiments, in which a probe device is shared by multiple users, a given user may give consent for probe data obtained from the device to be used for the purposes of the invention. Other users may not do so. The method may comprise determining when a user profile of the given user is active, and using probe data obtained from the device to identify whether the device is or has been present in the predetermined region only when the user profile is active. If a different user profile is active, the probe data may not be used.

In embodiments of the invention, the identity of a person associated with a given device or user profile of a device whose probe data is used in accordance with the invention may be known to the system as the user may have registered their device for use in accordance with the invention, i.e. when giving their consent for the probe data to be used. This may have occurred when initially setting up the device as an option, or subsequently if a user decided to opt into the system. The person may have provided contact information which may or may not involve contacting the user via the probe device. Thus the identity of a probe device may be used to obtain the preferred contact information set up by a user, which may then be stored in the database with or alternatively to information identifying the device.

The method may comprise storing information identifying the one or more probe devices found to be or have been present in the or a predetermined region in association with information identifying the building or attraction, and optionally identifying the predetermined region in which the device has been found. The information identifying the predetermined region may identify the extent of the region. This may be done directly or indirectly, e.g. by identifying the region using a code which is may be used to obtain information regarding the extent of the region. The system may comprise means for so doing. This may be useful where multiple regions are associated with a given building or attraction.

In embodiments in which a plurality of predetermined regions are associated with the same building or attraction, information identifying one or more probe devices which are or have been present in each predetermined region may be obtained, and used to generate a database of potential users of the building or attraction. A database of potential users may be generated for each region. Thus the database may comprise information identifying one or more probe devices, and associating each probe device with information identifying the predetermined region in which it was found to be present. Generating a database of potential users specific to or for each region may involve generating a separate database for each region, or data may be stored in a single database in a manner allowing potential users associated with each predetermined region to be identified.

The potential user of a probe device, or of the database in embodiments of the invention may be an individual person or an entity e.g. a company. References to a person may therefore refer to a natural or legal person.

It will be appreciated that the invention relies upon the assumption that the building or attraction is of relevance to a potential user because they are associated with a probe device that has been present in the region. In general this may provide an indication that the potential user was present in the region with the probe device.

In some embodiments the method comprises the step of obtaining information identifying one or more probe devices which are of have been present in the or a predetermined region in respect of a given time. Thus in these embodiments the database may be a database of potential users of the building or attraction for a given time. The given time may be a specific time or a time range as discussed below. For example, the time may be a time of day. A person associated with the building or attraction may specify that they wish to obtain a database relating to potential users for a particular time.

The step of using the obtained information to generate the database of potential users of the building or attraction may not simply involve including information identifying each probe device present, or which has been present in the region in the database. The step may further comprise selecting a subset of probe devices which are or have been present in the predetermined region for inclusion in the database. The subset may be a subset which meets certain criteria which may provide further confidence that the user of the device is likely to be a potential user of the building or attraction, or which suggest that the user of the device meets certain criteria that are of interest to a person associated with the building or attraction. The criteria may be set by a person associated with the building or attraction or other person who wishes to obtain the information regarding potential users. The method may comprise using the probe data to obtain information identifying one or more probe devices found to be or have been present in the predetermined region and which meet one or more further criteria, and including information identifying the or each device in the database only when the further criteria are met. The criteria may be criteria regarding one or more of; a pattern of movement of a probe device within the region, the frequency of presence of the device in the region, a time or times of presence of the probe device in the region, the proximity of the device to the building or attraction when present in the region, or the movement of the device relative to the building or attraction when in the region. For example, the time might be a time range or a specific time. The time may be a time of day. A promoter of a building or attraction may wish to obtain information about potential users who would be in the vicinity in the morning as this is a time period when they wish to try to attract more customers. Another example would be to find information about potential users who live in the area. This could be done by determining details of probe devices in the region on a given number of days per week between the hours of midnight and 5 am.

In some embodiments, the probe data for a probe device may be used to obtain further information about the device and/or the movement of the device which is stored in the database. This may enable the database to be searched for devices meeting certain additional criteria as desired. Thus all probe devices found in the region may be included in the database, with information enabling a search of the database to be carried out limited by certain criteria, avoiding the need to apply additional criteria in order to determine whether or not to include a probe device in the database. Storing of additional information may be useful in enabling a user of the database to establish more detail regarding the habits of a particular potential user, or their characteristics. In some embodiments the method further comprises using probe data for the devices found to be or have been present in the region to obtain information relating to one or more of; a frequency of presence of the device in the region, a time or times of presence of the device in the region, a pattern of movement of the device in the region, the proximity of the device to the building or attraction when present in the region, or the movement of the device relative to the building or attraction when in the region, and storing the information in the database, preferably in association with information identifying the device. For example, the time might be a time range or a specific time. The time may be a time of day. In some embodiments probe data relating to the position of the device for all time spent in the predetermined region may be stored. This may be achieved, e.g. by storing a probe trace. These embodiments would enable a promoter to search the database for example, for devices have visited the region at least 3 times in the afternoon.

The building or attraction may be any type building offering goods and/or services or any type of visitor attraction for which it is desired to obtain information identifying potential users for whom the building or its services or goods, or the attraction is relevant. The building or visitor attraction is one which a person may physically visit in order to take advantage of the goods or services or facilities on offer. The building or attraction will be a building or attraction wishing to attract users to the physical location of the building or attraction e.g. visitors or customers. The building or visitor attraction may be a commercial enterprise. In embodiments the building is a retail building. The building may be a shop, leisure facility, stadium, etc In other embodiments, the invention relates to a visitor attraction, such as a historical house, zoo, etc.

The method may further comprise storing information identifying the building or attraction and the or each predetermined region associated therewith, and the system comprises means for so doing. The information is preferably stored by the central controller. The method may comprise storing digital map data identifying the building or attraction and the or each predetermined region associated therewith. The predetermined geographic region may be a physical region represented by a predetermined region of a digital map i.e. the map being representative of the geographic location of the region in the real world. The building or attraction may be represented on the digital map. The building or attraction may be represented by a point based location on the digital map.

In accordance with the invention, the shape and size of the predetermined region are selected with regard to a type of the building or attraction and/or the location of the building or attraction. As the presence of a probe device in the predetermined region is used to obtain information for generating a database of potential users of the building or attraction, so-called “local users”, the shape and size of the region should be chosen such that the building or attraction would be of at least geographical relevance to someone located in the region. Thus the shape and size of the predetermined region are selected to provide a predetermined region defining a region in which the products and/or services offered by the building, or the visitor attraction, are of relevance i.e. at least geographical relevance.

The type of building or attraction may refer to the type of goods and/or services offered by the building or attraction. The type of building or attraction may alternatively or additionally refer to a physical size of the building or attraction, or to a type of organisation to which it belongs. Thus the type of the building or attraction may refer to a type of goods or services offered, a size of the building or attraction, or whether the building or attraction is a part of a chain or is an independent building or attraction.

The location of the building or attraction will refer to a geographic location of the building or attraction. The predetermined region may have a shape and size selected by reference to map features in the vicinity of the location of the building or attraction, e.g. such as a road network in the vicinity of the location of the building or attraction.

By way of example, people may travel some distance to events held at a sports stadium. Thus a relatively large region may be associated with a building or attraction which is a sports stadium. On the other hand, a bakery shop may be of relevance only to users in a closer proximity to the shop, such that a smaller region may be associated with such a building. This illustrates how the size of the region may be selected depending upon the type of the building or attraction. If the building or attraction is a branch of a chain, each particular branch may be of more limited relevance, indicating a smaller area would be appropriate.

The shape and size of the region may be selected dependent upon the location of the building or attraction. Thus if the building or attraction has a location close to a motorway, the region may have a shape/size selected so as to exclude the motorway to avoid probe devices of persons passing through the region on the motorway being identified. Similarly if the building or attraction is close to a park, the region may have a shape excluding the park.

In some embodiments the method may comprise associating a predetermined region of a first size and shape with a first building or attraction, and associating a predetermined region of a second different size and shape with another building or attraction, wherein the first and second buildings or attractions differ in type and/or location.

The or a predetermined region associated with the building or attraction may or may not include the building or attraction. The region may be of regular or irregular shape and may or may not be centred on the building or attraction. The predetermined region is preferably a region in the vicinity of the building or attraction. The region may include the building or attraction and a surrounding area. The region may be continuous or discontinuous. For example, the region may have a shape to exclude sub regions where it has been deemed that persons may be found who would are unlikely to be potential users of the building or attraction. Such regions might include motorways where people may be located as they travel through the region, and who would be unlikely to be potential users having an interest in stopping at the building or attraction.

In some embodiments the predetermined region may be a region defined by a given range of radius with respect to the building or attraction. In some embodiments the predetermined region is defined by a region between a first radius and a second radius with respect to the building or attraction.

The step of associating the at least one predetermined geographic region with the building or attraction in any of the embodiments described may be carried out by the central controller, where a central controller is provided. Whether or not a central controller is used, the method may comprise receiving an indication of a building or attraction, and associating a predetermined region with the area. The predetermined region could be set automatically, for example, it could be a region having a given radius with respect to the building or attraction for a given type or location of building or attraction, or an area of another preset configuration based on the location and/or type of building or attraction.

In preferred embodiments, the method comprises receiving an indication of the building or attraction and of the or each predetermined region to be associated with the building or attraction. A central controller may receive such an indication. Preferably the indication is made via a web interface, and the system comprises such an interface. In preferred embodiments the indication of the predetermined region includes a shape and size of the region selected based upon the type and/or location of the building or attraction. The region may have a size and shape selected by a person requesting the region to be associated with the building or attraction. The person may be a person wishing to obtain information identifying potential users of the building or attraction. Such a person may be a potential user of the database e.g. a commissioner of the database. The indication of the building or attraction and, in embodiments, the predetermined region may be set by, or in response to a request by, a person who wishes to obtain information regarding potential users for the building or attraction. For example, the building or attraction and/or predetermined region may be set via a website, or by contacting the system provider. In some embodiments the system comprises a web interface enabling such an indication to be provided. It will be appreciated that persons associated with buildings or attractions may subscribe to the system to enable them to set up regions and obtain database information obtained using the probe data. The person could be a business manager, owner, marketer or promoter of the building or its goods and/or services, or of the attraction.

In some embodiments the size and/or shape of the predetermined region is arranged to vary depending upon a time. The time may be a time range or a specific time. The size and/or shape of the region may vary continuously or in a one or more discrete steps with time. For example, the region may be of larger size in the afternoon than the morning. This may allow commuter movements to be excluded from the area in the rush hour, while expanding the area once more after the rush hour when persons travelling along the same roads may be more likely to be potential users of the building or attraction. Probe devices may then not need to be so close to the building or attraction to be considered potential users of the building or attraction in the afternoon, compared to the morning, for example, or a road system typically used for commuting may be excluded in the morning but not the afternoon etc. In this way, the shape and/or size of a region in which a probe device must be found in order to be added to the database may be different for different times e.g. times of day. A time varying predetermined region may be set up when the region is set up.

As mentioned above, in some embodiments an additional criteria may be specified which must be met for information identifying a probe device to be added to a database as a potential user in addition to the device being or having been present in the region. Such criteria may be associated with a given region. For example, a given predetermined region may be associated with a further criterion, such as a time criterion, and the probe data is then used to obtain information identifying one or more probe devices which are or have been present in the predetermined region and which meet the further criterion, the method including only probe devices found to be or have been present in the region and which meet the further criterion in the database. The criterion may be a user specified criterion. The criterion may be associated with a region in a similar manner to the associating of the region with the location. The time may be a specific time or a time range. The time may be a time of day.

It will be appreciated that a plurality of different predetermined regions may be associated with the same building or attraction. The regions may differ in size and/or shape. For example, in some embodiments, a plurality of regions at different distances from the building or attraction may be associated with the building or attraction. It may be of interest to a person associated with a building or attraction to know how close different potential users came to the building or attraction, to enable different promotions to be targeted to different groups of potential users, or different groups to be prioritised for promotions etc. In one exemplary embodiment a set of concentric regions centred upon the building or attraction may be associated with the building or attraction. Where multiple regions are provided, the regions may or may not overlap. In some embodiments a plurality of different regions are associated with the building or attraction, each region being associated with a different time criterion.

Where multiple predetermined regions are associated with the same building or attraction, the steps of the present invention in any of its embodiments may be carried out in relation to each region. Thus the database generated may be a database specific to the given predetermined region as discussed above. Each database specific to a region may be a separate database or a part of a larger database. Thus the databases for each region may be subsections of a database covering multiple sub regions, or may be separate databases for each sub region. In embodiments a database is preferably generated of potential users of the building or attraction for each predetermined region. Each database may then include details of a different group of potential users of the building or attraction. For example, the groups could be groups of users who are found closer or further from the building or attraction at a given time. The different databases generated could be used by the building or attraction in different ways.

References to a “time” or “given time” herein, may refer to a specific time or a time range e.g. day or days of the week, month, season, hour, or part of the day, month, year or hour, pattern of hours, days or months, specific time of hour, day, month, or year, time of day, combinations thereof etc.

As mentioned above, the steps of the method of the invention may be carried out by a central controller in preferred embodiments.

In accordance with a further aspect of the invention there is provided a central controller comprising;

means for associating at least one predetermined geographic region with one of a building offering goods and/or services or a visitor attraction, wherein a shape and size of the predetermined region is selected based on a type and/or location of the building or attraction;
means for using probe data to obtain information identifying one or more probe devices which are or have been present in the or each predetermined region,
and means for using the obtained information to generate a database of potential users of the building or attraction.

In accordance with a yet another aspect of the invention there is provided a method of operating a central controller comprising causing the central controller to carry out the steps of;

associating at least one predetermined geographic region with one of a building offering goods and/or services or a visitor attraction, a shape and size of the predetermined region being selected based on a type and/or location of the building or attraction;
using probe data to obtain information identifying one or more probe devices which are or have been present in the or each predetermined region,
and using the obtained information to generate a database of potential users of the building or attraction.

The central controller in these aspects may further comprise means for receiving an indication of the building or attraction and/or the predetermined region, and preferably a size and shape of the predetermined region based upon a type and/or location of the building or attraction, and the method may comprise the central controller receiving such an indication. The present invention extends to a system comprising the central controller and a web interface enabling a person to provide such an indication to the central controller. For example, the person could provide the indication via a user terminal using any technique e.g. using any form of user interface.

It will be appreciated that the present invention in accordance with these further aspects of the invention, and any other aspects of the invention, may comprise any or all of the features described in relation to the other aspects of the invention to the extent that they are not mutually inconsistent therewith.

The central controller may comprise a memory for storing the database.

It will be appreciated that in accordance with any of the aspects of the invention, the database may be used in a variety of manners.

In some embodiments the methods of the present invention further comprise using the database to obtain information relating to potential users of the building or attraction. The method may comprise using the database to provide information relating to the building or attraction to the potential users. This may comprise providing the information to the probe devices for which identifying information is stored. This may be done in any manner. For example the information may be pushed to devices. This may occur when the device is next found to be present in the predetermined region. The information may be in the form of a text message, voice message, email, etc. The method may comprise using the database to provide a first set of information to a first group of probe devices found to have been present in or present in a first predetermined region associated with the building or attraction, and providing a second different set of information to a second group of probe devices found to have been present in a second predetermined region associated with the building or attraction.

The information may comprise promotional information, advertisements, offers, etc. In some embodiments the information comprises an offer.

The information may be provided to all of the devices for which information is stored in the database for a given predetermined region, or a subset of the devices. In embodiments the information is provided to a group of devices which have been found to be in a predetermined region associated with the building or attraction and which meet a further criterion. The further criterion may be a time criterion, or a criterion regarding a frequency of presence in the region, a pattern of movement in the region etc. This may be done by providing the information to all devices for which information is stored in a database where information was only stored for devices meeting the criterion, or by searching among a database for devices meeting the criterion in other cases.

The database generated using information identifying probe devices which have been present in a given predetermined region may be used to define a target group of potential users of the location. Thus, where databases are generated using information identifying probe devices which have been present in multiple predetermined regions, each database may be specific to a predetermined region, and define a different target group of potential users. Information may be sent to one target group and not another, or different information may be sent to different groups.

In other embodiments the method may comprise providing at least a part of the database obtained to a person wishing to obtain information regarding potential users for the building or attraction. The central controller may be arranged to carry out such a step. The person may be any person who wishes to obtain information identifying potential users of the building or attraction. The person may be a person associated with the building or attraction of any of the types discussed above. The person may be the same person who, in embodiments, provides an indication of the building or attraction and/or a predetermined region. The at least a part of the database may be provided to the person for use in determining potential users for the building or attraction. The person may then use the database in the manners described above. The person may be a person who commissioned the database.

The method may comprise providing the at least a part of the database to the person in any manner. For example, the method may comprise providing the at least a part of the database to the person via a web interface, and the system may comprise a web interface for this purpose. The person may be able to download the at least a part of the database to a user terminal. The method may comprise providing a copy of at least a part of the database to the person.

The method in accordance with any of the embodiments of the invention may be repeated for multiple buildings or attractions, each having at least one predetermined region associated therewith.

The principles of the present invention are applicable to probe devices being any form of navigation apparatus. In accordance with any of the aspects or embodiments of the invention the navigation apparatus referred to herein may comprise a display for displaying a digital map to a user, a processor configured to access digital map data and cause a digital map to be displayed to a user via the display, and a user interface operable by a user to enable the user to interact with the apparatus.

The principles of the present invention in any of its aspects and embodiments are applicable to methods and systems using any form of navigation apparatus. One particular area of utility is in relation to portable navigation devices (PND). In embodiments, therefore, the navigation apparatus is an apparatus of a portable navigation device (PND). In accordance with a further aspect, the present invention provides a portable navigation device (PND) comprising the apparatus in accordance with any of the aspects or embodiments of the invention described.

The invention is also applicable to navigation apparatus which is provided as part of an integrated navigation system. For example the apparatus may form part of an in-vehicle integrated navigation system. In accordance with another aspect of the invention, the present invention provides a navigation system comprising a navigation apparatus in accordance with any of the aspects or embodiments of the invention described. The navigation system may be an integrated in-vehicle navigation system.

Regardless of its implementation, a navigation apparatus of the present invention may comprise a processor, memory, and digital map data stored within said memory. The processor and memory cooperate to provide an execution environment in which a software operating system may be established. One or more additional software programs may be provided to enable the functionality of the apparatus to be controlled, and to provide various other functions. A navigation apparatus of the invention may preferably include GPS (Global Positioning System) signal reception and processing functionality. The apparatus may comprise one or more output interfaces by means of which information may be relayed to the user. The output interface(s) may include a speaker for audible output in addition to the visual display. The apparatus may comprise input interfaces including one or more physical buttons to control on/off operation or other features of the apparatus.

In other embodiments, the navigation apparatus may be implemented by means of an application of a processing device which does not form part of a specific mapping or navigation device. For example the invention may be implemented using a suitable computer system arranged to execute mapping or navigation software. The system may be a mobile or portable computer system e.g. a mobile telephone or laptop.

The present invention extends to a computer program product comprising computer readable instructions executable to perform a method according to the invention in any of its aspects or embodiments.

The present invention extends to a computer program product comprising computer readable instructions executable when run on a central controller in accordance the invention in any of its embodiments to perform a method comprising the steps of; associating at least one predetermined geographic region with a building offering goods or services or a visitor attraction, wherein the size and shape of the region is selected based on the type and/or location of the building or visitor attraction; using probe data to obtain information identifying one or more probe devices which are or have been present in the or a predetermined region, and using the obtained information to generate a database of potential users of the building or attraction. The method performed may further comprise any of the steps described in respect to any of the other aspects or embodiments of the invention.

The present invention in accordance with the aspects may include any or all of the features described in relation to the other aspects of the invention in any of their embodiments to the extent they are not mutually inconsistent.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic illustration of a Global Positioning System (GPS);

FIG. 2 is a schematic illustration of electronic components arranged to provide a navigation device;

FIG. 3 is a schematic illustration of the manner in which a navigation device may receive information over a wireless communication channel;

FIGS. 4A and 4B are illustrative perspective views of a navigation device;

FIG. 5 is a flow chart illustrating an exemplary embodiment of the invention,

and FIG. 6 is a diagram showing an exemplary arrangement in which a plurality of predetermined regions are associated with a building.

### DETAILED DESCRIPTION OF PREFERRED EMBODIMENTS

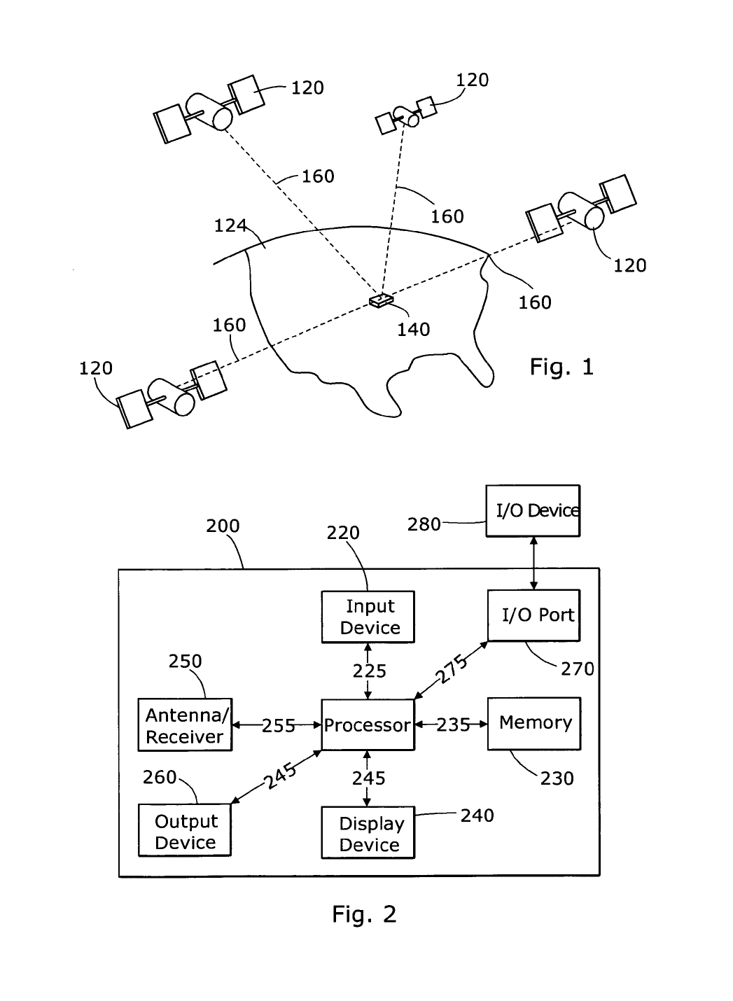

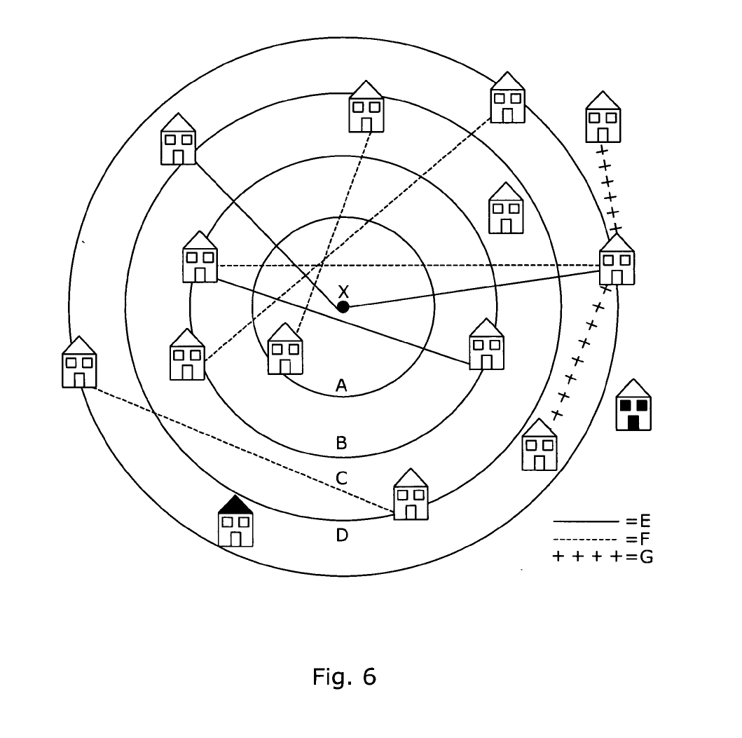

Some preferred embodiments of the invention will now be described by way of example only, and with reference to FIG. 5 and FIG. 6. The description with respect to FIGS. 1-4B provides background information to facilitate understanding of the invention in its various embodiments.

Preferred embodiments of the present invention will now be described with particular reference to a PND. It should be remembered, however, that the teachings of the present invention are not limited to PNDs but are instead universally applicable to any type of processing device that is configured to execute navigation software so as to provide route planning and navigation functionality. It follows therefore that in the context of the present application, a navigation device is intended to include (without limitation) any type of route planning and navigation device, irrespective of whether that device is embodied as a PND, a navigation device built into a vehicle, or indeed a computing resource (such as a desktop or portable personal computer (PC), mobile telephone or portable digital assistant (PDA)) executing route planning and navigation software.

It will also be apparent from the following that the teachings of the present invention even have utility in circumstances where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

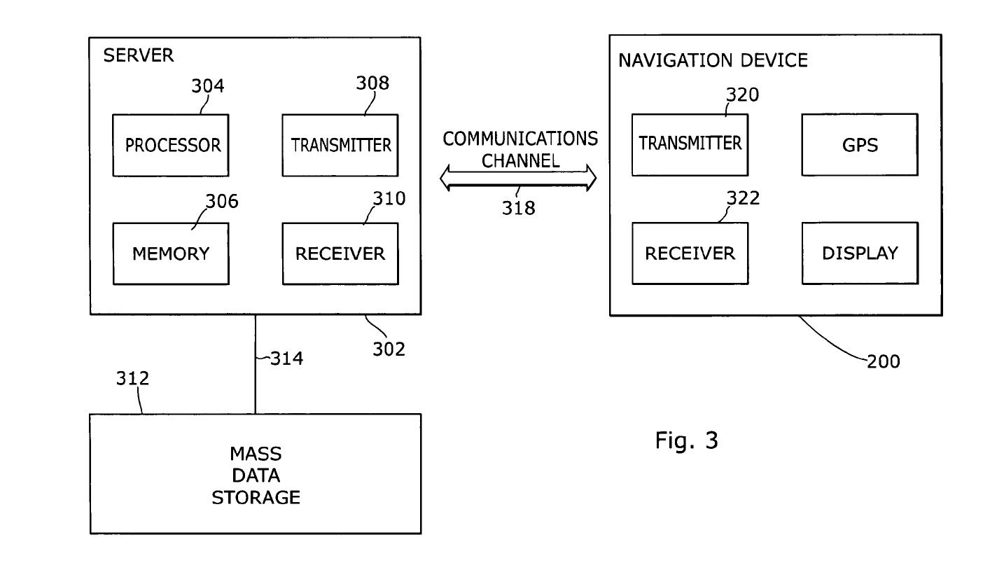

FIG. 2 is an illustrative representation of electronic components of a navigation device 200 according to a preferred embodiment of the present invention, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilised to input information; and the display screen 240 can include any type of display screen such as an LCD display, for example. In a particularly preferred arrangement the input device 220 and display screen 240 are integrated into an integrated input and display device, including a touchpad or touchscreen input so that a user need only touch a portion of the display screen 240 to select one of a plurality of display choices or to activate one of a plurality of virtual buttons.

The navigation device may include an output device 260, for example an audible output device (e.g. a loudspeaker). As output device 260 can produce audible information for a user of the navigation device 200, it is should equally be understood that input device 240 can include a microphone and software for receiving input voice commands as well.

In the navigation device 200, processor 210 is operatively connected to and set to receive input information from input device 220 via a connection 225, and operatively connected to at least one of display screen 240 and output device 260, via output connections 245, to output information thereto. Further, the processor 210 is operably coupled to a memory resource 230 via connection 235 and is further adapted to receive/send information from/to input/output (I/O) ports 270 via connection 275, wherein the I/O port 270 is connectable to an I/O device 280 external to the navigation device 200. The memory resource 230 comprises, for example, a volatile memory, such as a Random Access Memory (RAM) and a non-volatile memory, for example a digital memory, such as a flash memory. The external I/O device 280 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use.

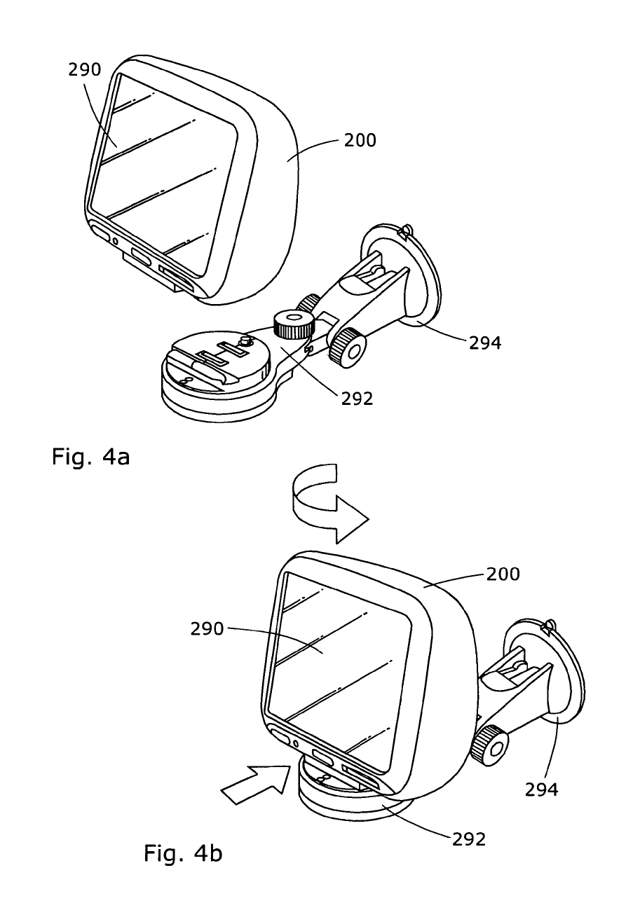

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet).

The navigation device 200 can further complete a data connection with the mobile device, and eventually with the internet and server 302, via existing Bluetooth technology for example, in a known manner, wherein the data protocol can utilize any number of standards, such as the GPRS, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GPRS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

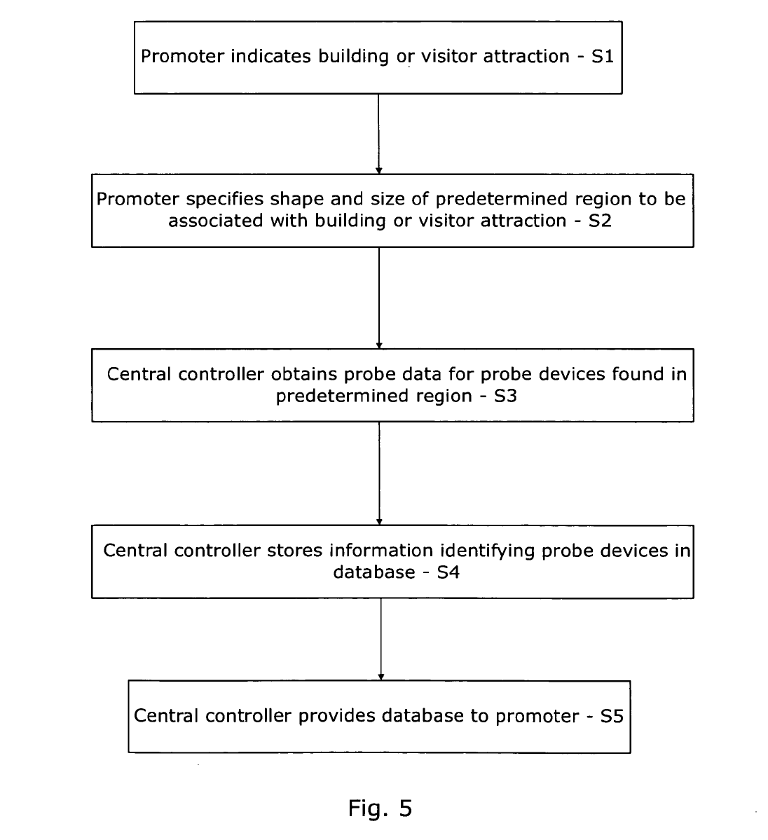

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 230, etc.).

The navigation device 200 may sit on an arm 292, which itself may be secured to a vehicle dashboard/window/etc. using a suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example. The navigation device 200 may then be rotatable on the arm 292, as shown by the arrow of FIG. 4B. To release the connection between the navigation device 200 and the docking station, a button on the navigation device 200 may be pressed, for example. Other equally suitable arrangements for coupling and decoupling the navigation device to a docking station are well known to persons of ordinary skill in the art.

Some preferred embodiments of the invention will now be described by reference to FIG. 5 and FIG. 6.

The Applicant has realised that while progress has been made in targeting internet advertisements to particular categories of user, or to users who are likely to be interested in particular goods or services, corresponding advances have not been made in targeting promotional material relating to goods or services offered by physical buildings, or relating to visitor attractions in the real world. For example, buildings offering goods or services might be shops, leisure facilities etc. Conventional methods of marketing buildings or visitor attractions tend to still involve marketing sections of the population blindly. An important factor in determining the success of promotional activity for such physical entities is whether a recipient of promotional material is local to the entity in some sense, whether by living nearby, having visited before, passing by regularly on the way to work etc. People who are “local” will be more likely to respond to promotional activity, such as offers or advertisements, and consider visiting the entity, or if they have visited previously, making a return visit.

A first embodiment of the invention will now described by reference to the flow chart FIG. 5 which may provide a way for a person wishing to identify potential local users of a building i.e. of the goods or services offered thereby to obtain a database identifying potential users who may be considered local, in that they can be assumed to have been present within the proximity of the building. For exemplary purposes, the invention will be described by reference to a building in the form of a shop, but would be equally applicable to other types of building or visitor attraction.

In accordance with a first step of the method, S1, a person wishing to obtain information regarding potential local users of a building or attraction indicates the identity of the building or attraction via a web interface to a central controller. This may be done via a user terminal. For example, the person may indicate the location representing the physical location of the building or attraction upon a displayed digital map. In this example the building is a sports shop. Alternatively the person could contact the service provider by telephone to specify the shop. The person may be a business manager or owner for the shop, or a marketer etc. For ease of reference, the person will be referred to as “the promoter”. The promoter may have set up an account e.g. with a navigation system provider to enable them to obtain database information in return for a fee, perhaps based upon the number of new users obtained through the database. The promoter may agree to provide discounts or offers to those whose details are provided.

Next the promoter specifies a predetermined region to be associated with the shop—S2. Again, this may be done via a website, or in another manner such as by telephone. The region will typically be indicated as a region of a digital map representing a region in proximity to the shop. The predetermined region is a region which encompasses a geographic area in which the promoter considers the services/goods offered by the sports shop may be relevant.

In accordance with the invention, the database of potential users is determined on the basis of the inferred presence of users within the predetermined region. Thus the size and shape of the region should be selected as appropriate to define a region where the shop or its goods/services may be relevant. The size and shape of the region will depend upon the type and the location of the shop. In the case of the sports shop, users may be prepared to travel a moderate distance to take advantage of the goods/services on offer, and a correspondingly sized region is indicated. If the shop were a large superstore, a larger region may be indicated, as people may travel a considerable distance to the shop. If the shop were a small bakery, a smaller region may be indicated as shop would be expected to be of only direct local interest. In other examples, a facility of national or regional level interest, such as a national swimming centre or conference centre may have a large predetermined region associated therewith. A branch of a chain of restaurants may have a relatively small region associated therewith as users in other areas would travel to a different nearer branch.

The shape and size of the predetermined region may also depend upon the location of the e.g. shop. If the shop is near a motorway, the region incorporating the motorway may be omitted from the predetermined region. Likewise a country park nearby may be omitted as neither is likely to yield potential local users of the shop. Thus the shape may depend upon map features in the vicinity of the location of the shop.

The indicated predetermined region may or may not be continuous, and may or may not be centered on the location of the shop. The region may include the location of the building.

Once the shop has been indicated, and the predetermined region associated with it, in step S3, the central controller obtains probe data for probe devices which have been found to be present in the region. This may be obtained by collecting probe data relating to probe devices in a geographic region including the predetermined region. The data may be in the form of probe traces tracking the path of individual devices with respect to time. Such probe traces may be superposed on a digital map representing the predetermined region, and used to determine whether the probe traces include a portion which passes through the predetermined region. The probe traces may be collected for a given time e.g. a specific time or time range, such as a particular day of the week, or part of the day. The promoter may specify the part of the day of interest, for which the database is to relate,

The probe devices are any device which can provide position information and corresponding time information to the central controller. In exemplary embodiments the probe devices are mobile telephones or PND devices. The mobile telephone may be a mobile telephone which runs navigation software. Other forms of probe device could be used. In accordance with the present invention the presence of probe devices in the predetermined region is determined, and it is assumed that these are indicative of the presence of a user of the probe device at the same location. Thus the probe device should be a probe device which is typically portable, and associated with an individual user. In the event that a probe device is a device normally used by multiple users, the method may involve determining that the device is present in the predetermined region with a particular user profile active. The probe devices may be probe devices of persons who have given consent for their devices to be tracked for the purposes of the invention. For example, such a possibility may be offered to a person when buying a mobile phone or navigation device. The user may sign up for such a scheme on the basis that they will receive special offers or discounts from entities determined to be of local relevance to them.

In step S4 the information identifying the probe devices, and enabling communication to be established with the devices, is stored in a database. Such information may include a device identifier and/or an address or number for the device which can be used to contact the user of the device. This may be a phone number, email address, account details etc. Details of the user of the device may be obtained via the device information and may also be stored. For example, the details of a registered owner, or one whose user profile is active, may be obtained and stored. In this way a database of potential local users of the shop is provided. The potential users are local users, as the probe data shows that they, or at least a probe device with which they are associated, has been present in the region which defines a zone of interest for the shop. By storing information identifying a probe device in a database, the user of the device may be contacted via the device. This enables the database to be used to target potential users with promotional material.

In step S5 the central controller provides the database to the promoter via a web interface. The promoter may then use the database to send promotional material, such as offers, to the probe devices/device users whose details are included in the database. The promoter may be confident that the shop will be of at least geographic relevance to those targeted. The promoter may download the database from a website. For example, the database may be accessible via a user account of the promoter.

In some embodiments further details regarding the movement of the individual probe devices with respect to the predetermined region are stored in the database. For example information may be stored regarding the number of visits of the probe device to the region, the time spent in the region, the time of day when the visit was made, whether the device actually visited the shop etc. The promoter may then search the database to extract information regarding certain categories of probe devices and hence potential users i.e. those which visit the region daily, appear to live near the shop or have visited it before, and target promotions or offers accordingly at those categories.

In another arrangement, it is envisaged that the promoter might specify additional criteria to be associated with the predetermined region, such that only information identifying probe devices/potential users which meet this further criteria are stored in the database. A further criteria might similarly be a criteria regarding a frequency with which the probe device is found in the region, a duration of stay, time of day of visit etc. This may enable a more focussed database to be obtained.

It is envisaged that at some times of day, the details of potential users who pass less close to the location of the shop may be of greater interest than at other times. For example, in the rush hour, many people and hence probe devices may pass near the shop on the way to work if a major road is present. Later in the morning people travelling along the road are more likely to be potential users of the shop, as people often use the same road for shopping trips. Thus the predetermined region may be specified by the promoter to have a size or shape which varies according to time. In this example, it may have a shape to exclude the road during the rush hour, but to include it once again later in the morning. Thus a predetermined region may be set up which has a different size and/or shape depending upon the time of day.

In some arrangements multiple predetermined regions are associated with the same shop. These regions may for example be regions at greater distance from the shop. It may be determined using probe data when a probe device has been found in any of the further regions in the same manner described in respect to the first region. A database of potential users may be determined from the data for each specific predetermined region. Each database may provide a database of a particular group of users which may be used by the promoter. For example, users associated with regions further from the shop may be targeted in a different manner to those who pass very close by, or even have visited the shop.

One example of how multiple regions may be associated with the same shop is illustrated with respect to FIG. 6.

FIG. 6 shows a location X, being a shop. Four regions have been associated with this shop. These are in the form of zones having different ranges of radius from the shop and are labelled A, B, C and D with increasing distance from the shop location respectively.

FIG. 6 schematically indicates probe traces from probe devices which are found to be present in each of the zones over a given period. Some of the probe traces represent actual visits to the shop. These are indicated by the solid lines E. Some probe traces show routes taken between points which are in the outermost zone D or beyond. These are indicated by the dotted lines having cross-hatching G.

A number of other routes F are shown in dotted lines which were taken by probe devices between locations and involve crossing or being present in one or more of the closer zones A, B or C.

The zones A, B, C and D may be considered to be regions of progressively less interest to a promoter of the shop. In other words the shop owner is more interested in obtaining information about potential users who have been found in the inner zones than in the outer zone, as it is less likely that they would be interested in visiting the shop, and be “local”. In this case, a database may be created including information identifying the probe devices which are associated with the probe traces including portions in any of the regions A, B, C or D, and provided to the promoter. The database may include information regarding the zone in which a particular device was found. The promoter may then target promotional activity initially towards users of probe devices which have visited one of the inner zones before targeting those who have been present only in an outer zone, or may target these different groups in different ways. The database may include details of an actual path taken by a probe device within a zone, and whether or not the shop was actually visited. This may allow promotions to be targeted, for example to previous visitors to the shop, those who spent considerable amounts of time in the zone etc.

The database may be used to obtain aggregate data regarding patterns of movement of probe devices to allow a promoter to view, for example, relative numbers of probe devices and proximity of the probe devices to the shop location at certain times of day. Thus the database may be used to yield information about general patterns of behaviour of potential shop users, as well as providing information regarding identities of specific devices and hence potential users. The promoter may be able to view information regarding the proximity of users at different times of day to the shop location using for example a graphical view. This may help them to determine how best to place physical advertisements such as billboards, or signs to attract more customers in addition to direct marketing techniques.

The present invention provides methods which may more effectively allow promotional and other material to be targeted at users to whom it is likely to be relevant at least geographically. The association of a predetermined region with an attraction or a building offering goods or services enables relevant users to be identified according to the specifications of the promoter who may choose the size and shape of the region appropriately.

The business owner could focus on a particular group of potential users and target the promotions towards them. For example, users who have been found to have visited the location already in a given month, who live within a certain range, and arrive in a particular time frame could be determined and targeted with a relevant promotion.

The methods of the invention may lead to better relationships between customers and vendors. The techniques may be applicable even to smaller or medium enterprises, as they may be implemented at low cost and without the need for the vendor to have any specific infrastructure. The system may be a web based system and may be offered by a navigation system operator. A navigation server may be provided that could provide a web portal where a vendor may set up an account. Here he may be able to specify the predetermined regions in order to obtain a desired database, and view or download the database which has been generated. The store owner may be able to carry out other operations, for example to see a statistical profile of the users, the number of people that have visited the building/attraction, or have been within the predetermined range, and may even obtain further details of where they came from and where they are travelling towards using collected probe data.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, whilst embodiments described in the foregoing detailed description refer to GPS, it should be noted that the navigation device may utilise any kind of position sensing technology as an alternative to (or indeed in addition to) GPS. For example, the navigation device may utilise other global navigation satellite systems, such as the European Galileo system. Equally, it is not limited to satellite-based systems, but could readily function using ground-based beacons or other kind of system that enables the device to determine its geographic location.

It will also be well understood by persons of ordinary skill in the art that whilst the preferred embodiment may implement certain functionality by means of software, that functionality could equally be implemented solely in hardware (for example by means of one or more SICs (application specific integrated circuit)) or indeed by a mix of hardware and software.

Lastly, it should be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specially enumerated in the accompanying claims at this time.

1. A method comprising the steps of:
associating at least one predetermined geographic region with one of a building offering goods and/or services or a visitor attraction;
selecting a shape and size of the predetermined region based on a type and/or location of the building or attraction;
using probe data to obtain information identifying one or more probe devices which are or have been present in the or each predetermined region; and
using the obtained information to generate a database of potential users of the building or attraction.

2. (canceled)

3. The method of claim 1, wherein said steps of associating the predetermined region with a building or attraction, using the probe data to obtain information identifying the one or more probe devices and using the obtained information to generate a database are carried out be a central controller, the method further comprising receiving at the central controller an indication of at least one of the location and the predetermined region to be associated with the location.

4. The method of claim 3, wherein the indication is provided via a web interface.

5. The method of claim 1, wherein the probe devices are mobile communications devices or portable navigation devices.

6. The method of claim 1, wherein the step of using the obtained information to generate a database comprises storing the information identifying the one or more probe devices in a database in association with information identifying the building or attraction and/or the predetermined region in which the devices are or have been found to be present.

7. The method of claim 1, comprising using the probe data for the or each probe device which is or has been found to be present in the or a predetermined region to obtain information relating to one or more of:
a frequency of presence of the device in the region;
a time or times of presence of the device in the region;
a pattern of movement of the device in the region;
the proximity of the device to the building or attraction when present in the region; and
the movement of the device relative to the building or attraction when in the region, and storing the information in the database.

8. The method of claim 1, wherein the size and/or shape of the predetermined region is selected dependent upon a type of goods or services offered by a building.

9. The method of claim 1, wherein the size and/or shape of the predetermined region is arranged to vary depending upon time.

10. The method of claim 1, comprising associating a plurality of different predetermined geographic areas with the same building or attraction.

11. The method of claim 1, comprising using the database to provide information relating to the building or attraction to potential users of the building or attraction.

12. The method of claim 1, comprising providing at least a part of the database to a person wishing to obtain information identifying potential users of the building or attraction.

13. A system comprising at least one processor, the at least one processor being configured to:
associate at least one predetermined geographic region with one of a building offering products and/or services or a visitor attraction, wherein a shape and size of the predetermined region is selected based on a type and/or location of the building or attraction;
use probe data to obtain information identifying one or more probe devices which are or have been present in the or each predetermined region; and
use the obtained information to generate a database of potential users of the building or attraction.

14-21. (canceled)

22. A non-transitory computer readable medium comprising computer readable instructions which, when executed by a computer, cause the computer to perform the method of claim 1.

23. (canceled)
